(19) United States
(12) Patent Application Publication
(10) Pub. No.: US 2025/0044413 A1
(43) Pub. Date: Feb. 6, 2025

(54) LIDAR DATA COMPRESSION AND PROCESSING

(71) Applicants: Kevin Wong, Newark, CA (US); Ankur Jai Sood, Menlo Park, CA (US)

(72) Inventors: Kevin Wong, Newark, CA (US); Ankur Jai Sood, Menlo Park, CA (US)

(21) Appl. No.: 18/705,334

(22) PCT Filed: Oct. 27, 2022
(86) PCT No.: PCT/US2022/078808

§ 371 Date: Apr. 26, 2024

Related U.S. Application Data
(60) Provisional application No. 63/263,302, filed on Oct. 29, 2021.

(51) Int. Cl. G01S 7/48; G01S 7/00; G01S 17/58; G01S 17/89; G01S 17/931

(52) U.S. Cl. CPC G01S 7/4808; G01S 7/003; G01S 17/58; G01S 17/89; G01S 17/931

(57) ABSTRACT

Described systems and techniques enable fast and efficient compression of lidar data for analysis and other processing, without disrupting a primary processing path of the lidar data. Consequently, it is possible to identify, transmit, and store a desired subset of lidar data in a fast and efficient manner, while continuing to use the lidar data for a primary purpose, such as autonomous driving and control of a vehicle. For example, lidar sensor data may be received from at least one lidar sensor disposed on a vehicle, and a subset of the lidar sensor data may be collected in a compression buffer. The subset of the lidar sensor data from the compression buffer may be compressed to obtain compressed lidar sensor data, and the compressed lidar sensor data may be transmitted from the vehicle for remote processing of the lidar sensor data to characterize vehicle movement.

### CROSS-REFERENCE TO RELATED APPLICATION

This application claims priority to U.S. Patent Application No. 63/263,302, filed on Oct. 29, 2021, and entitled “LIDAR DATA COMPRESSION AND PROCESSING,” the disclosure of which is incorporated by reference herein in its entirety.

### TECHNICAL FIELD

This description relates to lidar data compression and related processing of the lidar data.

### BACKGROUND

Light detection and ranging (lidar) sensors use laser light to calculate a distance of a remote object. For example, a lidar sensor may emit laser light pulses into a surrounding environment, which then encounter objects in the surrounding environment. Detected pulses that return to the lidar sensor after being reflected by the encountered objects may be used to calculate the distance between the lidar sensor and each of the objects.

By using a large enough number of light pulses over an area, lidar sensors may be used to generate a three-dimensional map of the area in x, y, z coordinates. Moreover, as lidar sensors are fast and accurate, it is possible to track moving objects, even at high speeds. As a result, lidar sensors may be used to enable autonomous driving or control for automobiles and other vehicles.

### SUMMARY

According to general aspects, a computer program product may be tangibly embodied on a non-transitory computer-readable storage medium and may comprise instructions that, when executed by at least one computing device, are configured to cause the at least one computing device to receive lidar sensor data from at least one lidar sensor disposed on a vehicle and characterizing vehicle movement of the vehicle, and collect a subset of the lidar sensor data in a compression buffer. The instructions, when executed by the at least one computing device, may be configured to cause the at least one computing device to compress the subset of the lidar sensor data from the compression buffer using a lossless compression algorithm to obtain compressed lidar sensor data, and transmit the compressed lidar sensor data from the vehicle for remote processing of the lidar sensor data to characterize the vehicle movement.

In example implementations, the lidar sensor data includes network data packets. Validation data may be collected with the subset of lidar sensor data. The validation data may be transmitted with the compressed lidar sensor data. The lidar sensor data may be collected in a compression buffer in response to a detected event. The lidar sensor data may be converted to point cloud format at the vehicle and used for navigation of the vehicle. The lidar sensor data may be collected in a shared buffer that is shared by a point cloud converter to perform the point cloud conversion at the vehicle and by a compression manager to fill the compression buffer with the subset of lidar data for compression thereof. The compression buffer may capture the subset of lidar data from the shared buffer, including lidar data preceding the detected event and lidar data occurring subsequent to the detected event. The compressed lidar sensor data may be received for remote processing and decompressed using validation data transmitted with the compressed lidar sensor data. The decompressed lidar sensor data may be converted to point cloud format during the remote processing.

According to other general aspects, a computer-implemented method may include receiving lidar sensor data from at least one lidar sensor disposed on a vehicle and characterizing vehicle movement of the vehicle and collecting a subset of the lidar sensor data in a compression buffer. The method may include compressing the subset of the lidar sensor data from the compression buffer using a lossless compression algorithm to obtain compressed lidar sensor data, and transmitting the compressed lidar sensor data from the vehicle for remote processing of the lidar sensor data to characterize the vehicle movement.

In example implementations, validation data is collected with the subset of lidar sensor data and transmitted with the compressed lidar sensor data. The method may include collecting the lidar sensor data in the compression buffer in response to a detected event. The method may include converting the lidar sensor data to point cloud format at the vehicle for navigation of the vehicle. The method may include collecting the lidar sensor data in a shared buffer that is shared by a point cloud converter to perform the point cloud conversion at the vehicle and by a compression manager to fill the compression buffer with the subset of lidar data for compression thereof. The method may include capturing, e.g., at the compression buffer, the subset of lidar data from the shared buffer, including lidar data preceding the detected event and lidar data occurring subsequent to the detected event.

According to other general aspects, a vehicle may include a chassis, a frame mounted on the chassis, a motor mounted within the frame, a plurality of sensors mounted on the vehicle and configured to generate sensor data characterizing an environment of the vehicle, at least one memory including instructions, and at least one processor that is operably coupled to the at least one memory and that is arranged and configured to execute instructions. When executed, the instructions may cause the at least one processor to receive lidar sensor data from at least one lidar sensor of the plurality of sensors, and collect a subset of the lidar sensor data in a compression buffer. When executed, the instructions may cause the at least one processor to compress the subset of the lidar sensor data from the compression buffer using a lossless compression algorithm to obtain compressed lidar sensor data, and transmit the compressed lidar sensor data from the vehicle for remote processing of the lidar sensor data to characterize the vehicle movement.

In example implementations, the lidar sensor data is collected in the compression buffer in response to a detected event. The lidar sensor data may be converted to point cloud format at the vehicle and used for navigation of the vehicle. The lidar sensor data may be collected in a shared buffer that is shared by a point cloud converter to perform the point cloud conversion at the vehicle and by a compression manager to fill the compression buffer with the subset of lidar data for compression thereof.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for lidar data compression and processing.

FIG. 2 is a block diagram illustrating a more detailed example of the system of FIG. 1 when used for lidar sensor data compression and analysis.

FIG. 3 is a flow chart illustrating more detailed examples of operations of the system of FIG. 1.

FIG. 4 is a flowchart illustrating more detailed examples of a process for capturing and compressing lidar sensor data.

FIG. 5 is a flowchart illustrating more detailed examples of a process for decompressing and analysing lidar sensor data.

### DETAILED DESCRIPTION

Described systems and techniques enable fast and efficient compression of lidar data for analysis and other processing, without disrupting a primary processing path of the lidar data. Consequently, it is possible to identify, transmit, and store a desired subset of lidar data in a fast and efficient manner, while continuing to use the lidar data for a primary purpose, such as autonomous driving and control of a vehicle.

Lidar sensors typically record and store data using floating point notation. Floating point notation provides high precision over a wide range of numbers and corresponding distances.

Lidar data is typically recorded, using floating point notation, as point cloud data. A point cloud refers to a set of data collected from a plurality of individual laser pulses of a lidar sensor during scanning of an area, expressed as three-dimensional coordinates characterizing objects in the area. Point cloud data also may include other information, such as data characterizing a relative level of reflective intensity of returned laser pulses.

Thus, lidar data may be represented and stored, for example, as 32-bit floating-point Point Cloud data, which may be used, for example, to enable autonomous driving of a vehicle. In the context of autonomous driving, it is important for lidar data to be collected and processed in a manner that is fast and accurate, and in sufficient quantities to ensure the safety of passengers in the vehicle, as well as the safety of any persons, objects, or animals in a vicinity of the vehicle.

As a result, vehicle lidars typically collect and process vast quantities of lidar data. Further, such lidar data is typically collected across large windows of time and for many different drivers and vehicles. Moreover, it is difficult to compress floating point data in an effective manner. For these and related reasons, it is infeasible to implement transmission and/or long-term storage of all such lidar data.

Nonetheless, such lidar data contains potentially valuable information. For example, collected lidar data may be analyzed to improve an accuracy level of autonomous driving algorithms. Moreover, lidar data collected around a time of an accident or other driving event may be instrumental in predicting and avoiding accidents and other events in the future. Therefore, it is desirable to capture, transmit, and store minimally sufficient quantities (subsets) of lidar data that are likely to include such valuable information.

Described techniques determine and select event-related lidar data that may be helpful in analyzing driving events and improving a self-driving ability of a vehicle. The event-related lidar data may be intercepted and captured as raw data packets output from the lidar sensor(s), prior to conversion of the data packets into standard 32-bit floating-point Point Cloud data.

Then, the captured data packets may be compressed using a lossless compression algorithm. The compressed event-related lidar data may then be transmitted to a central location. At the central location, the compressed data may be decompressed for further processing. For example, the decompressed data may be converted to floating-point point cloud data for analysis.

Accordingly, it is possible to analyze event-related lidar data across many different events experienced by many different drivers and vehicles. As a result, self-driving capabilities of the vehicles may be improved, and the safety and convenience of the drivers may be enhanced.

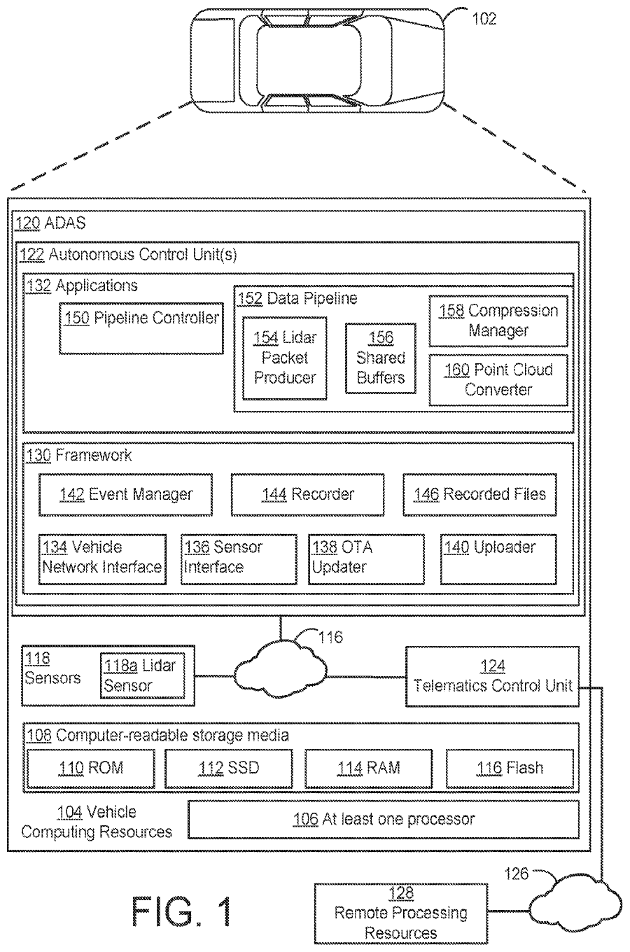

In the example of FIG. 1, a vehicle 102 is illustrated as a car, but should be understood to represent any type of automobile or automotive vehicle. In other example implementations, the vehicle 102 may represent any mobile, autonomous or semi-autonomous device, including, e.g., a robot, an airplane, a boat, or a drone.

The vehicle 102 may thus include a body of desired type (e.g., a chassis, a frame mounted on the chassis with doors, windows, a roof, trunk, and/or hood), various components for enabling movement of the vehicle, such as wheels/wings, and a suitable motor, such as an electric motor (and associated battery) or internal combustion engine (not separately illustrated in FIG. 1). Various types of vehicle computing resources 104, which may include many different types and configurations of hardware and software resources, may also be included. In the simplified example of FIG. 1, the vehicle computing resources 104 are illustrated as including at least one processor 106, and non-transitory computer-readable storage medium 108.

For example, the at least one processor 106 may represent multiple processors, chipsets, or processing cores. The computer-readable storage medium 108 may represent multiple types of memories, including, e.g., read-only memories (ROM) 110, solid state drives (SSD) 112, random access memories (RAM) 114, or flash memories (Flash) 116.

The vehicle computational resources 104 may also include network hardware used to create a vehicle network 116 within the vehicle 102. For example, the vehicle network 116 may represent, e.g., wiring and related hardware/software to provide one or more busses and related protocols for distributing data within the vehicle 102. As such, the vehicle network 116 provides opportunities for intra-vehicle communication between and among various vehicle subsystems, as described in detail, below.

For example, the vehicle network 116 may utilize existing types of vehicle bus topologies and related busses, including, e.g., the Controller Area Network (CAN) bus, the Local Interconnect Network (LIN) bus, or the Media Oriented Systems Transport (MOST). The network 116 may also represent automotive-grade Ethernet and various types of Transport Control Protocol/Internet Protocol (TCP/IP) networks.

In some implementations, two or more of these technologies may be combined or utilized together. For example, a physical Ethernet connection may be established throughout the vehicle 102 (e.g., as an Ethernet ring that encircles a chassis and/or cabin of the vehicle 102), and may be used to aggregate or distribute multiple CAN busses.

In many implementations, the vehicle 102 may include multiple sensors 118, which may be used to detect information regarding an environment or surroundings of the vehicle 102. For example, the sensors 118 may include video cameras, Light Detection and Ranging (lidar) sensors, radar sensors, GPS sensors, and various other types of sensors. The sensors 118 may be distributed within and around a chassis, body, and/or cabin of the vehicle 102, where needed to perform intended functions.

In the simplified example of FIG. 1, the vehicle computational resources 104, including the at least one processor 106, the non-transitory computer-readable storage medium 108, the vehicle network 116, and the sensors 118, are illustrated together for ease of illustration and description. Within the vehicle 102, however, as already noted with respect to the vehicle network 116 and the sensors 118, multiple pairs or groups of processors and memories may be distributed in desired locations within the vehicle 102, together with other related hardware, to provide intended functionalities.

For example, multiple control boards may be assembled using desired ones of the at least one processor 106 and the computer-readable storage media 108, and positioned appropriately within the vehicle 102 to perform desired functions. Such control boards and related hardware and software may be referred to generally as electronic control units (ECUs). For example, one or more ECUs may be used to support and enable corresponding vehicle subsystems. Examples of current vehicle subsystems may include subsystems for navigation, including an advanced driver assistance system (ADAS) 120 for autonomous or semi-autonomous systems, which may include one or more Autonomous Control Units (ACUs) 122. Various other vehicle subsystems may relate to, or include, subsystems for vehicle safety features, climate control, and information/entertainment (infotainment) systems.

Another example of an ECU is illustrated in FIG. 1 as telematics control unit (TCU) 124. The TCU 124 may represent a single site of network connectivity for connecting the vehicle 102 to external network(s) 126. Maintaining the TCU 124 as a single site of network connectivity may provide efficiency by reducing or eliminating a need to reproduce connectivity components (e.g., hardware modems) at multiple locations, or for multiple vehicle subsystems, within the vehicle 102.

Moreover, maintaining a single site of network connectivity may assist in protecting the vehicle 102 from various types of cyberattacks. For example, the TCU 124 may be equipped with firewalls and various other protection mechanisms used to prevent attackers from, e.g., controlling operations or the vehicle 102, or accessing confidential information within the vehicle 102.

The TCU 124 may include multiple modems and/or related hardware (including appropriate ones of the at least one processor 106 and the computer-readable storage media 108) for connecting to two or more external networks 126. For example, the TCU 124 may provide external connectivity to WiFi networks, long term evolution (LTE) networks, or 3G/4G/5G networks.

Accordingly, it is possible to use the external networks 126 to exchange vehicle information with remote processing resources 128. For example, as described in detail, below, it is possible to perform over-the-air (OTA) updates of software stored using the computer-readable storage media 108, or to upload navigation data from the vehicle 102 to the remote processing resources 128 for analysis or long-term storage.

As further illustrated, the ACU 122 may include a framework 130. The framework may include an operating system (OS) that, e.g., supports operations of one or more applications 132 of the ACU 122, and that enables connectivity with the vehicle network 116. For example, the framework 130 may provide or include an implementation of the Automotive Open Source Architecture (Autosar), which is designed to support deployment of the applications 132 using an operating system based on the Portable OS Interface (POSIX) standard, which is written using C++ and enables service-oriented communication and application programming interfaces (APIs) for communicating with, e.g., the vehicle network 116 and the applications 132. Additionally, or alternatively, the framework 130 may include other OS implementations, such as automotive grade Linux.

In the example of FIG. 1, the framework 130 is illustrated as including a vehicle network interface 134 for communicating with the vehicle network 116. The framework 130 also includes a sensor interface 136, which represents one or more interfaces for obtaining sensor data from the appropriate ones of the sensors 118.

An OTA updater 138 represents a component for receiving updates of the vehicle 102 via the external networks 126. For example, new or updated software may be downloaded via the TCU 124 and installed by the OTA updater 138 within an appropriate or designated memory of the computer-readable storage media 108.

An uploader 140 may be configured to execute any desired transmission of data from the vehicle 102 to the external networks 126, using the vehicle network 116 and the TCU 124. For example, the uploader 140 may be configured to upload processed sensor data, or any vehicle data, to the remote processing resources 128.

An event manager 142 represents a component for detecting, determining, processing, and/or characterizing network data received via the vehicle network interface 134 and/or sensor data received via the sensor interface 136, and for then using the network data and/or sensor data, e.g., to control other functions of the framework 130 and the applications 132. Put another way, the event manager 140 represents a control node for controlling and coordinating operations of the framework 130 and the applications 132, to thereby achieve coordinated functions such as, e.g., sensor fusion, multi-layer perception processing algorithms, and autonomous driving control algorithms for controlling steering, braking, or other functions of the vehicle 102.

In specific examples, the event manager 142 may be configured to control operations of a recorder 144 in recording various types of vehicle data, including sensor data, for storage as recorded files 146. For example, the recorded files 146 may be used to store sensor data related to particular events, including driving-related events such as sudden accelerations/decelerations, or impact events including collisions of the vehicle 102. Then, some or all of the recorded files 146 may be uploaded to the external networks 126, and to the remote processing resources 128, using the uploader 140.

In the simplified example of FIG. 1, the various components or modules 134, 136, 138, 140, 142, 144, 146 of the framework 130 are illustrated as singular, individual modules implemented entirely in the context of the framework 130. In various implementations, however, it will be appreciated that specific features and functions of one or more of the framework modules 134, 136, 138, 140, 142, 144, 146 may be implemented in the context of the applications 132, i.e., as application-layer functions. For example, policies of the event manager 142 in defining and controlling sensor events processed by one or more application(s) 132 and recorded by the recorder 144 for uploading by the uploader 140 may be partially or completely governed or implemented at the application layer of the applications 132.

In the example of FIG. 1, the sensors 118 are illustrated as including at least one lidar sensor 118a. For example, multiple lidar sensors may be disposed at various locations on the vehicle 102, and lidar sensor data streams may be received at a corresponding sensor interface(s) 136 of one or more ACU(s) 122.

For example, the lidar sensor data stream may be generated by the lidar sensor 118a as network data packets transmitted to the sensor interface 136 of the ACU 122 using the vehicle network 116. For example, the network data packets may be transmitted as user datagram protocol (UDP) packets or transmission control protocol (TCP) packets, e.g., using the Internet Protocol (IP).

To utilize these lidar data packets with respect to maintaining the control, safety, and utilization of the vehicle 102, the event manager 142 and/or one or more of the applications 132 may process the lidar data packets received from the sensor interface 136. In the example of FIG. 1, a pipeline controller 150 is configured to configure and control a data pipeline 152 to process sensor data in a fast and efficient manner.

For example, the data pipeline 152 may include one or more producer nodes, including a lidar packet producer 154, which may output data to a pool of shared buffers 156. Both a compression manager 158 and a point cloud converter 160 may be configured to access the shared buffers 156. Accordingly, both the compression manager 158 and the point cloud converter 160 may be provided with desired access to the lidar data packets produced by the lidar packet producer 154, while minimizing or reducing a need to copy the lidar data packets to multiple memory locations (e.g., to multiple buffers).

As referenced above, and described in more detail, below, the point cloud converter 160 may be configured to decode and convert a stream of received lidar data packets into 32 bit floating-point point cloud format, to thereby represent a plurality of point clouds. As is known, for example, laser pulses from a lidar sensor may be considered to be a collection of points in Cartesian two dimensional (x, y) or three dimensional (x, y, z) coordinates, and may be generated, e.g., from a rotating three-dimensional multilayer lidar sensor.

Although not specifically illustrated in FIG. 1 in detail, resulting point clouds may be used for vehicle control as part of the ADAS 120. For example, resulting point clouds may be routed through the vehicle network interface 134 and over the vehicle network. 116 to an appropriate ECU for vehicle control. For example, such vehicle control may include steering or braking of the vehicle 102. Accordingly, point cloud data from the point cloud converter 160 represents an extremely large volume of high priority data, which must be transmitted and processed quickly and accurately to maintain safe operation of the vehicle 102.

Nonetheless, much of this point cloud data cannot, or should not, be transmitted or stored for long term use. In particular, quantities of local storage at the computer-readable storage media 108 may be very limited, while quantities of point cloud data, and other vehicle control data, may be generated continuously in vast quantities.

Moreover, there may be little need or motivation to attempt to store much or all of the vehicle control data. For example, the vehicle 102 may travel for a period of time uneventfully, with all sensor and control functionalities occurring as expected. Further, the vehicle 102 may travel for many hours, and the vehicle 102 may represent many thousands of vehicles, so that it would be impractical, impossible, and undesirable to attempt so store such data either locally at the vehicle 102 and/or using the remote processing resources 128. Still further, attempting to store and analyze large or continuous quantities of vehicle sensor and control data may increase a likelihood of identifying the vehicle 102 uniquely, and thereby compromising a privacy of a user of the vehicle 102.

On the other hand, capturing important and meaningful vehicle events that may occur during use of the vehicle 102 may represent critical opportunities to improve relevant sensor and control (e.g., navigation) algorithms. For example, such event-specific vehicle data may represent, or correspond to, malfunctions or crashes of the vehicle 102.

Other events may relate to unexpected or undesirable driving conditions, such as sudden turns, accelerations, or decelerations. Such events may be correlated with, or caused by, external events, such as hazardous road conditions. In other examples, such events may be cause by driver error or distraction.

By capturing sensor and control data related to such events, the ADAS 120 enables fast, efficient, cost-effective analysis of operations of the vehicle 102, without overwhelming available resources for data storage, transmission, and analysis. As a result, it is possible to continuously improve the vehicle 102, including improvements to vehicle self-navigation and safety of users of the vehicle 102.

As referenced above, the event manager 142, and/or one or more of the applications 132, may be configured to define such events, as well as related event parameters characterizing a manner and extent to which related event data is captured, stored, transmitted, and analyzed. For example, the event manager 142 may specify a number of seconds of sensor data before and after an event (e.g., a collision) that should be captured, stored, and transmitted to the remote processing resources 128. Then, the pipeline controller 150 may be configured to control the data pipeline 152 to implement event data capture according to the specifications of the event manager 142.

Therefore, some of the functions of the data pipeline 152 may relate to storing captured event data locally at the vehicle 102, and/or transmitting captured event data to the remote processing resources 128. However, techniques for such storage, transmission, and analysis of event data may vary widely based on various factors, such as a type and priority of the data, or of the event related to the data. For example, event data related to a collision may need to be transmitted quickly, perhaps in advance of a potential or actual malfunction of related hardware (e.g., damage to the TCU 124, or loss of power for executing a transmission).

In order to transmit and store event data in a fast and efficient manner, it may be desirable or necessary to compress the event data. For example, it may be necessary to compress sensor data obtained from the sensor 118 and related to, or included in, relevant event data.

As the sensors 118 may represent multiple types of sensors, it may occur that some sensor data is relatively straightforward to compress in a desired manner, or to a desired extent. For example, in the case where a sensor is a video camera, a desired one of many well-known compression techniques that exist for compressing video data may be selected.

In the case of lidar sensor data from the lidar sensor 118a, however, it is difficult or impractical to compress an output of the point cloud converter 160 in a desired manner or to a desired extent. For example, output of the point cloud converter 160 may be recorded (e.g., written to a file) in the form of 32-bit floating-point Point Cloud data. Such floating-point data is known to be difficult to compress, and, in particular, difficult for compressing using lossless compression algorithms.

In more detail, example techniques for writing lidar sensor data include writing out the 32-bit floating point Point Cloud data to file using four 32-bit floating point numbers. X, Y, Z, and Intensity. Lossless compression of such 32-bit floating point Point Clouds may achieve, e.g., approximately only a 20% size reduction of the full point cloud size.

In the example of FIG. 1, however, the compression manager 158 and related techniques may be used to implement an integer-based compression algorithm, to enable efficient data recording and data transfer of lidar sensor data. More particularly, the compression manager 158 may be configured to accumulate lidar data packets from the vehicle network 116, execute a lossless compression algorithm directly on the data packets independently of the operations of the point cloud converter 160, and then write the resulting compressed packets to file (e.g., in the recorded files 146) for transmission over the external network 126 to the remote processing resources 128.

Thus, the system and techniques of FIG. 1 provide an extremely fast and efficient method for compressing, transmitting, storing, and analyzing lidar sensor data, without interrupting or delaying a primary processing of the lidar sensor data for purposes of control and operation of the vehicle 102. As shown in FIG. 1, lidar data packets received from the lidar sensor 118a via the network 116 and the sensor interface 136 are not decoded or otherwise converted into 32-bit floating-point Point Clouds for purposes of compression and transmission.

Instead, the raw lidar sensor data packets remain as raw lidar data packets, in which information is stored using integer-type values. Storing lidar data packets instead of 32-bit floating-point Point Cloud data provides a comparative reduction of file size by at least about 40%. Introducing an additional lossless compression algorithm, as described in more detail, below, may further reduce the data size. The final file size, in comparison to the original uncompressed point cloud data type, may be between 1% to 40% of the original file size, dependent to some extent upon the contents of the data being compressed. Therefore, described techniques accomplish at least a 60% reduction in file size, as compared to conventional techniques.

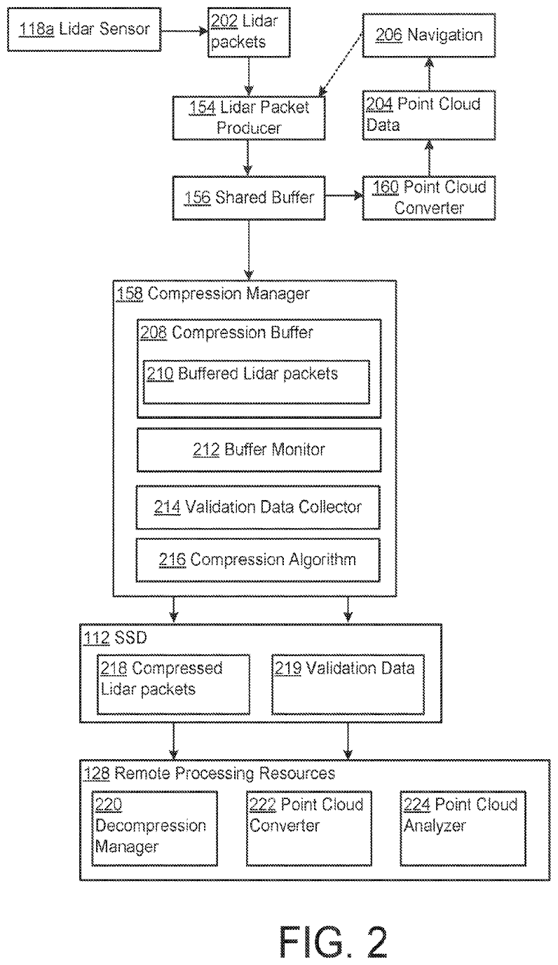

FIG. 2 is a block diagram of a more detailed example implementation of the system of FIG. 1. In the example of FIG. 2, the lidar sensor 118a outputs lidar packets 202. As described, the lidar packets 202 represent raw, data packets, such as UDP packets, output by the lidar sensor 118a and transmitted via the vehicle network 116 and the sensor interface 136 of FIG. 1.

FIG. 2 further illustrates the lidar packet producer 154 of the data pipeline 152 of FIG. 1. In general, the data pipeline 152 represents an example of a producer/consumer design pattern for, among other purposes, capturing lidar network packets.

For example, the lidar packet producer 154 may be configured to capture the lidar packets 202 without decoding or converting the lidar packets 202, and prior to conversion of the lidar packets 202 by the point cloud converter 160. Instead, as shown and described, the lidar packet producer 154 may be configured to store the lidar packets 202 within the shared buffer 156. For example, the shared buffer 156 may be implemented using the RAM 114 of FIG. 1, e.g., using a designated address space within an instance of the RAM 114 provided on the ACU 122.

In the producer/consumer design pattern of FIG. 2, there may be multiple consumers for each producer. In particular, as shown, there may be at least two consumers, the compression manager 158 and the point cloud converter 160. Both of the compression manager 158 and the point cloud converter 160 may have access to the shared buffer 156, and may therefore be configured to consume the buffered lidar packets therefrom.

For example, although not separately illustrated in FIG. 2, each of lidar packet producer 154, the compression manager 158, and the point cloud converter 160 may be configured to receive at least one control signal from the pipeline controller 150 and/or the event manager 142. The control signal may start, stop, or pause either or both of the compression manager 158 and the point cloud converter 160 with respect to accessing to the shared buffer 156. In other implementations, the lidar packet producer 154 may manage access of each of the compression manager 158 and the point cloud converter 160 to the shared buffer, and/or a publish/subscribe (pub/sub) architecture may be used. In additional or alternative implementations, the compression manager 158 and the point cloud converter 160 may have internal queues and/or consumption policies to dictate whether, when, and how to consume buffered lidar packets from the shared buffer.

For example, the point cloud converter 160 may be configured to consume the lidar packets from the shared buffer 156 and output point cloud data 204. The point cloud data 204 may be forwarded to, and used by, one or more navigation subsystems, or to various analysis systems, or for other related purposes. As such purposes may be time-sensitive and mission-critical to operating the vehicle 102 in a safe, desired manner, the point cloud converter 160 may have a default priority to consume available lidar sensor data from the shared buffer 156.

Upon completion of a pre-defined event, the compression manager 158 may be provided with priority access to the shared buffer 156. For example, the navigation system 206 may communicate to the lidar packet producer 154 that a vehicle event has occurred, such as a sudden acceleration/deceleration, a collision, a sharp turn, or any other driving event. The compression manager 158 may be configured to begin filling a separate compression buffer 208 with buffered lidar packets 210 from the shared buffer 156.

A buffer monitor 212 may be configured to determine whether and when the compression buffer 208 reaches a desired size for compression to begin. A validation data collector 214 may be configured to determine and collect various types of validation data to ensure proper compression/decompression of the buffered lidar packets 210, as well as to enable synchronization and correlation with other sensors during later analysis operations. For example, the validation data collector 214 may be configured to capture a timestamp of each lidar sensor packet, as well as a size of each packet and a total size of the lidar sensor packets from the compression buffer 208.

In more detail, the compression buffer 208 may be used to collect a pre-specified quantity of the buffered lidar packets 210. For example, upon determination that a predesignated vehicle event has occurred, the compression manager may be configured to begin to fill the compression buffer 208 with a preceding thirty seconds worth of lidar sensor packets from the shared buffer 156, and to continue filling the compression buffer 208 with a subsequent thirty seconds worth of lidar sensor packets from the shared buffer 156. The compression buffer 208 is not required to be completely filled, and may be partially filled to any desired extent.

Thus, in the example, the buffer monitor 212 may determine when the buffered lidar packets 210 represent the configured sixty seconds worth of buffered lidar sensor packets. Of course, the compression buffer 208 may be configured to capture any specified timing and duration of lidar sensor packets from the shared buffer 156. For example, the compression buffer 208 may be larger in size than the shared buffer 156, e.g., may be a single binary buffer provided with a larger address space in RAM 114 than the shared buffer 156. In this way, a desired quantity of lidar data packets may be accumulated in the compression buffer 208.

A compression algorithm 216 may be configured to receive the specified quantity of buffered lidar packets 210 from the compression buffer 208, for compression into compressed lidar packets 218. For example, the compression algorithm 216 may be a lossless compression algorithm. For example, the compression algorithm 216 may include, or be obtained from, the zlib software library used for data compression. In other example implementations, additional or alternative algorithms may be used, such as GNU gzip, zip extractor, or PKZIP.

The compressed lidar packets 218 and corresponding validation data 219 may then be output from the compression manager 158. For example, the compressed lidar compression packets 218 and the validation data 219 may be recorded by the recorder 144 to be stored locally at the ACU 122 for a period of time, e.g., in a suitable hard drive. In other examples, the compressed lidar compression packets 218 and the validation data 219 may be provided directly to the uploader 140 and then over the vehicle network 116 to the TCU 124, for transmission over the external network 126 to the remote processing resources 128. In some examples, the compressed lidar packets 218 and the validation data 219 may be recorded by the recorder 144 as a binary file(s) temporarily stored in a queue at the ACU 122 with other files to be uploaded by the uploader 140, and then uploaded according to relatively priority levels determined, e.g., by the event manager 142.

The compressed lidar packets 218 may include, or be transmitted with, some or all of the validation data 219 collected by the validation data collector 214. For example, as reference, the validation data 219 may include a timestamp of each lidar data packet, a total size of the uncompressed buffered lidar packets 210 input to the compression algorithm, a total compressed size of the compressed lidar packets 218, and a checksum calculated with respect to the buffered lidar packets 210 and/or the compressed lidar packets 218. For example, a checksum algorithm may be implemented at the compression manager 158 to calculate the checksum. The compressed lidar packets 218 and the validation data 219 may be stored, for example, in the SSD 112 or other suitable local memory, until upload to the remote processing resources 128 occurs, e.g., via the uploader 140 and the TCU 124.

The remote processing resources 128 may represent a provider or servicer of the vehicle 102, e.g., a manufacturer of the vehicle 102, or an agent of the manufacturer. The remote processing resources 128 may include a decompression algorithm 220, which may be configured to decompress the compressed lidar packets 218.

For example, the decompression manager 220 may be configured to use a decompression algorithm corresponding to the compression algorithm 216. Additionally, the decompression manager 220 may be configured to use the validation data to perform decompression validation, to ensure that there is no corruption of, or tampering with, the compressed lidar packets 218. For example, the decompression manager 220 may use the same checksum algorithm used by the compression manager 216 to validate the previously-calculated checksum.

Then, a point cloud converter 222 may convert the decompressed data packets into point clouds, e.g., into 32-bit floating-point point cloud format. For example, the originally captured, decompressed lidar packets 202 may contain information identifying themselves as being part of a specific, individual point cloud. The point cloud converter 222 may therefore be configured to determine a packet that is a first packet of a point cloud, as well as a subsequent packet in the stream of packets that is a final packet of the same point cloud. Once a packet that is the end of a point cloud has been reached, so that a complete point cloud is determined, then the point cloud converter may continue decoding of a subsequent point cloud.

In some implementations, the compression buffer 208 may be configured to capture the buffered lidar packets 210 with a first lidar data packet thereof including a first lidar data packet of a first point cloud, and a final lidar packet thereof including a final point cloud. In other implementations, the compressed lidar packets 218 may contain orphan packets, e.g., either initial packets and/or final packets that are not part of a complete point cloud. In such cases, the point cloud converter 222 may be configured to recognize and disregard such orphan packets when constructing point clouds from the compressed lidar packets 218.

A point cloud analyzer 224 may be configured to then perform various types of analyses of the point clouds. For example, as referenced, the compressed lidar packets 218 may include, or be transmitted with, timestamps of the original lidar data packets 202. The point cloud analyzer may use these timestamps to synchronize point clouds for analysis, e.g., with operations of other ones of the sensors 118 at the time of the event, in response to which collection of the buffered lidar packets 210 was triggered.

The point cloud analyzer 224 may be configured to identify errors in various sensor operations, and/or errors in the manner in which sensor data was processed and used. For example, machine learning algorithms may be used to process sensor data to make decisions regarding perception and navigation with respect to operations of the vehicle 102. The point cloud analyzer 224 may be configured to identify such errors and/or to retrain the machine learning algorithms to correct for such errors in future processing.

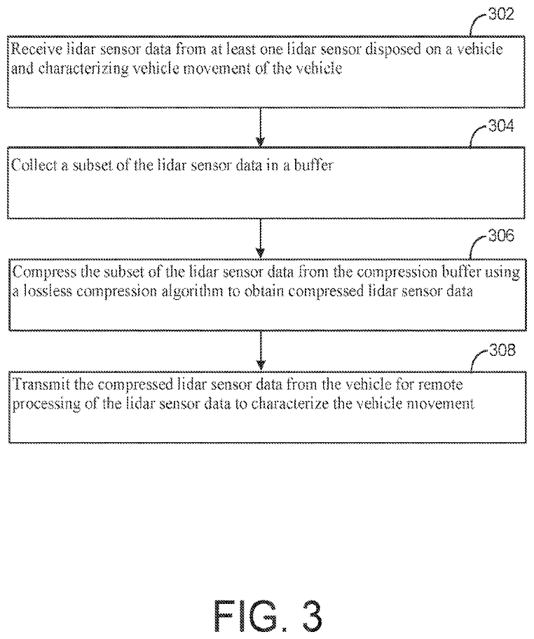

FIG. 3 is a flowchart illustrating example operations of the system of FIG. 1. In the example of FIG. 3, operations 302-308 are illustrated as separate, sequential operations. In various implementations, the operations 302-308 may include sub-operations, may be performed in a different order, may include alternative or additional operations, or may omit one or more operations. Further, in all such implementations, included operations may be performed in an iterative, looped, nested, or branched fashion.

In the example of FIG. 3, lidar sensor data may be received from at least one lidar sensor disposed on a vehicle and characterizing vehicle movement of the vehicle (302). For example, lidar sensor data, e.g., lidar data packets 202, may be received from the lidar sensor 118a of FIGS. 1 and 2, e.g., at the lidar packet producer 154. As described above, the lidar data packets 202 may be stored in the shared buffer 156, e.g., in a first-in-first-out (FIFO) manner. The point cloud converter 160 may access the shared buffer 156 to produce the point cloud data 204, which may then be used by navigation systems 206, as described herein.

A subset of the lidar sensor data may be collected in a compression buffer (304). For example, the compression manager 158 may be configured to capture the subset of lidar sensor data using the compression buffer 208. As described, the buffered lidar packets 210 may represent a pre-defined quantity or duration specified with respect to a vehicle event captured by the navigation system 206.

The subset of the lidar sensor data from the compression buffer may be compressed using a lossless compression algorithm to obtain compressed lidar sensor data (306). For example, once the buffer monitor 212 has determined that a sufficient quantity of buffered lidar data packets 210 have been captured in the compression buffer 208, the compression manager 158 may execute the compression algorithm 216 to generated the compressed lidar packets 218.

The compressed lidar sensor data may be transmitted from the vehicle for remote processing of the vehicle movement (308). For example, the compression manager 158 may transmit the compressed lidar packets 218 to the remote processing resources 128.

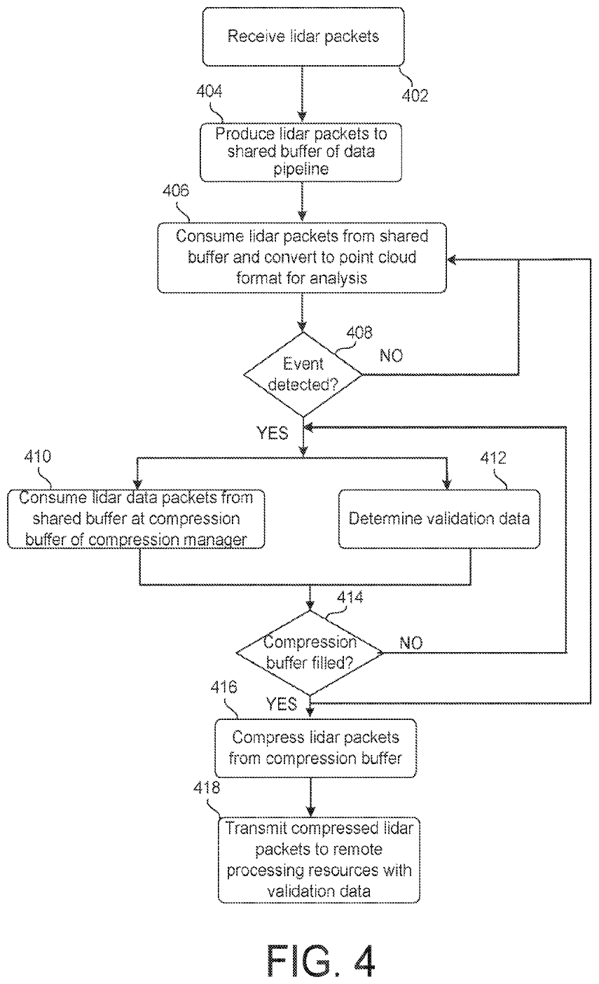

FIG. 4 is a flowchart illustrating more detailed examples of a process for capturing and compressing lidar sensor data. In FIG. 4, lidar packets are received (402), e.g., from one or more lidar sensors represented by the lidar sensor 118a.

The lidar packets may then be produced, e.g., by the lidar packet producer 154, to a shared buffer 156 that is part of a data pipeline for operating the vehicle 102 (404). For example, the shared buffer 156 may be implemented in RAM, for fast read/write access. For example, the shared buffer 156 may be implemented as a circular buffer that is defined with a maximum size, so that lidar packets are aged out (e.g., expired and/or deleted) from the shared buffer 156 after a defined period of time.

The lidar packets may be regularly consumed from the shared buffer 156 and converted to point cloud format for point cloud analysis (406). For example, the point cloud converter 160 may produce the point cloud data 204 for use by navigation systems 206. As described, the point cloud data 204 may be considered high priority data that is processed as quickly as possible to ensure a safety and accuracy of operations of the navigation system 206.

Such navigation operations may continue as—expected for a period of time, and, as long as no vehicle event is detected (408), corresponding consumption of additional lidar packets by the point cloud converter 160 may continue, as well (408). For example, as long as the vehicle 102 is operated within expected ranges and/or parameters, navigation may continue and lidar data within the shared buffer 156 may be aged out, expired, or otherwise deleted, as referenced above. In this way, the shared buffer 156 may be provided with a relatively small size that does not require the storage of excessive amounts of data that is unlikely to be needed or used in the future. As a result, for example, the RAM 114 may be used in an efficient, cost-effective, and space-effective manner.

If an event is detected (408), however, e.g., if the navigation system 206 determines that a type of vehicle event referenced herein has occurred, then lidar data packets may be consumed from the shared buffer 156 and stored in the compression buffer 208 (410), while corresponding validation data is also determined (412). For example, the shared buffer 156 may be provided with a maximum size corresponding to a maximum duration of lidar packets captured, e.g., thirty seconds, or one minute, or some other first time period. Meanwhile, the compression buffer 208 may be provided with a maximum size corresponding to a maximum duration of lidar packets needed for event analysis, e.g., 90 seconds, or two minutes, or some other second time period that is larger than the first time period of the shared buffer 156.

In this way, it is possible to minimize the size of the shared buffer 156 for navigation purposes, as referenced above, while still ensuring that the compression buffer 208 captures sufficient data for event analysis. For example, the navigation system 206 may use fifteen seconds of lidar data for navigation functions, while the shared buffer 156 may have a maximum size of one minute. Upon detection of a vehicle event at time t, the compression manager 158 may capture a preceding time period of (t−30) seconds from within the shared buffer 156, while continuing to capture a subsequent (t+30) seconds. In this way, the compression buffer 208 may be filled with one minute's worth of lidar data packets, occurring +/−30 seconds of the detected vehicle event.

Therefore, as shown in FIG. 4, the compression manager 158 may continue to fill the compression buffer 208 until the compression buffer 208 is filled with the specified quantity and duration of data with respect to the vehicle event (414). Subsequently, the lidar data packets from the compression buffer 208 may be compressed (416).

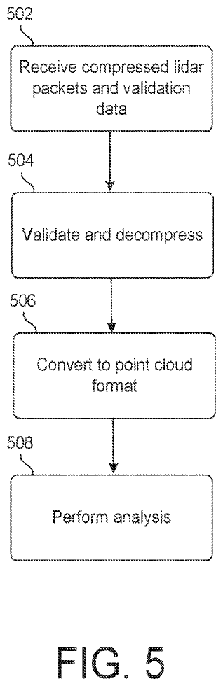

In example implementations, the lidar data packets are not processed before being compressed. Validation data 219, such as timestamp, total packets size, compressed size, and checksum may also be captured, and the compressed lidar packets 218 and validation data 219 may be transmitted to remote processing resources 128 for processing (418), as described in more detail with respect to FIG. 5.

For example, as illustrated in FIG. 1 and FIG. 4, the compressed lidar packets 218 and validation data 219 may be stored locally at the vehicle 102 using an appropriate memory, e.g., the SSD 112, until uploading via the uploader 140 and the TCU 124 may proceed. In example implementations, an upload priority may be set for the locally-stored data.

For example, in the event of a collision, the locally-stored compressed lidar packets 218 and the validation packets 219 may be immediately uploaded by the uploader 140 to the remote processing resources 128. In other examples, however, such as a sudden acceleration/deceleration, the locally-stored compressed lidar packets 218 and the validation packets 219 may be uploaded after a specified quantity of data has been captured, and/or until a suitable connection to the external network(s) 126 is available.

FIG. 5 is a flowchart illustrating more detailed examples of a process for decompressing and analysing lidar sensor data. In the example of FIG. 5, the compressed lidar packets 218 and the validation packets 219 may be received at the decompression manager 220 of the remote processing resources 128 (502).

The compressed lidar packets 218 and the validation packets 219 may then be validated and decompressed (504). For example, as referenced above, a total size, compressed size, and checksum may be used for decompression validation. Consequently, the decompression manager 220 may ensure that no file corruption has occurred, or, alternatively, may determine that corruption may have occurred and will not attempt to decompress corresponding received file(s).

The decompressed lidar data may then be converted to point cloud format (506). For example, the point clout converter 222 may analyze the decompressed lidar packets to determine an end of a current point cloud and/or a beginning of a subsequent point cloud, so that multiple point clouds may be determined from a single stream of lidar packet data.

Accordingly, analysis may performed with respect to the thus-obtained point clouds (508). For example, vehicle events may be examined to determine an effect of an event (such as an effect of a sudden acceleration/deceleration, or sharp turn), or to determine a cause of the vehicle event (such as a cause of a collision). Further, a timestamp of the validation data 219, and/or various types of sensor calibration data, may be used for synchronization with sensors other than the lidar sensor 118a, to assist in validation processing.

Implementations of the various techniques described herein may be implemented in digital electronic circuitry or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include. by way of example, both general and special purpose microprocessors and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may, or be operatively coupled to, receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
receive lidar sensor data from at least one lidar sensor disposed on a vehicle and characterizing vehicle movement of the vehicle;
collect a subset of the lidar sensor data in a compression buffer;
compress the subset of the lidar sensor data from the compression buffer using a lossless compression algorithm to obtain compressed lidar sensor data; and
transmit the compressed lidar sensor data from the vehicle for remote processing of the lidar sensor data to characterize the vehicle movement.

2. The computer program product of claim 1, wherein the lidar sensor data includes network data packets.

3. The computer program product of claim 1, wherein validation data is collected with the subset of lidar sensor data.

4. The computer program product of claim 3, wherein the validation data is transmitted with the compressed lidar sensor data.

5. The computer program product of claim 1, wherein the lidar sensor data is collected in the compression buffer in response to a detected event.

6. The computer program product of claim 5, wherein the lidar sensor data is converted to point cloud format at the vehicle and used for navigation of the vehicle.

7. The computer program product of claim 6, wherein the lidar sensor data is collected in a shared buffer that is shared by a point cloud converter to perform point cloud conversion at the vehicle and by a compression manager to fill the compression buffer with the subset of lidar data for compression thereof.

8. The computer program product of claim 7, wherein the compression buffer captures the subset of lidar data from the shared buffer, including lidar data preceding the detected event and lidar data occurring subsequent to the detected event.

9. The computer program product of claim 1, wherein the compressed lidar sensor data is received for remote processing and decompressed using validation data transmitted with the compressed lidar sensor data.

10. The computer program product of claim 9, wherein the decompressed lidar sensor data is converted to point cloud format during the remote processing.

11. A computer-implemented method, comprising
receiving lidar sensor data from at least one lidar sensor disposed on a vehicle and characterizing vehicle movement of the vehicle;
collecting a subset of the lidar sensor data in a compression buffer,
compressing the subset of the lidar sensor data from the compression buffer using a lossless compression algorithm to obtain compressed lidar sensor data; and
transmitting the compressed lidar sensor data from the vehicle for remote processing of the lidar sensor data to characterize the vehicle movement.

12. The method of claim 11, wherein validation data is collected with the subset of lidar sensor data and transmitted with the compressed lidar sensor data.

13. The method of claim 11, further comprising collecting the lidar sensor data in the compression buffer in response to a detected event.

14. The method of claim 13, further comprising converting the lidar sensor data to point cloud format at the vehicle for navigation of the vehicle.

15. The method of claim 14, comprising collecting the lidar sensor data in a shared buffer that is shared by a point cloud converter to perform point cloud conversion at the vehicle and by a compression manager to fill the compression buffer with the subset of lidar data for compression thereof.

16. The method of claim 15, wherein the compression buffer captures the subset of lidar data from the shared buffer, including lidar data preceding the detected event and lidar data occurring subsequent to the detected event.

17. A vehicle comprising:
a chassis;
a frame mounted on the chassis;
a motor mounted within the frame;
a plurality of sensors mounted on the vehicle and configured to generate sensor data characterizing an environment of the vehicle;
at least one memory including instructions; and
at least one processor that is operably coupled to the at least one memory and that is arranged and configured to execute instructions that, when executed, cause the at least one processor to
receive lidar sensor data from at least one lidar sensor of the plurality of sensors;
collect a subset of the lidar sensor data in a compression buffer;
compress the subset of the lidar sensor data from the compression buffer using a lossless compression algorithm to obtain compressed lidar sensor data; and
transmit the compressed lidar sensor data from the vehicle for remote processing of the lidar sensor data to characterize the vehicle movement.

18. The vehicle of claim 17, wherein the lidar sensor data is collected in the compression buffer in response to a detected event.

19. The vehicle of claim 18, wherein the lidar sensor data is converted to point cloud format at the vehicle and used for navigation of the vehicle.

20. The vehicle of claim 19, wherein the lidar sensor data is collected in a shared buffer that is shared by a point cloud converter to perform point cloud conversion at the vehicle and by a compression manager to fill the compression buffer with the subset of lidar data for compression thereof.
